(19) United States
(12) Patent Application Publication
(10) Pub. No.: US 2012/0097510 A1
(43) Pub. Date: Apr. 26, 2012

(54) Apparatus and Method for Child Proofing a Personal Electronic Device

(76) Inventor: Robert Mendel Mitchell, Venice, CA (US)

(21) Appl. No.: 13/275,602

(22) Filed: Oct. 18, 2011

Related U.S. Application Data
(60) Provisional application No. 61/406,971, filed on Oct. 26, 2010.

(51) Int. Cl. H01H 13/04

(52) U.S. Cl. 200/333

(57) ABSTRACT

An apparatus for preventing young children from activating a push button switch while allowing adults to activate said button. The apparatus is a semi-rigid child-proof cover or cap for the “home button” or menu button on a personal electronic device or computing tablet. The cap is disposed over the push button switch and prevents young children from pressing it because the strength necessary to bend the semi-rigid material of the cap is beyond that of young children. However, adults have sufficient strength to push the semi-rigid material with enough force that it bends and thus exerts a downward pressure and activates the push button below it. A small hole may also be defined in middle of the cap that allows an adult to use a paperclip or other pointed object to activate the button, while being too small for a young child's finger to pass through and activate the button.

### RELATED APPLICATIONS

The present application is related to U.S. Provisional Patent Application Ser. No. 61/406,971, filed on Oct. 26, 2010, which is incorporated herein by reference and to which priority is claimed pursuant to 35 USC 119.

### BACKGROUND

1. Field of the Technology

The disclosure relates to the field of personal electronics and mobile device accessories, specifically to an apparatus for child proofing said personal electronics.

2. Description of the Prior Art

There are many tens of millions of Apple® iPhone®, iPad™, and iPod Touch® and other similar personal electronic devices being used all over the world. The vast majority of owners of Apple® iPhone®, iPad™, and iPod Touch® and other similar devices are adults, and many of these device owners have young children. Said personal electronic devices can download and play games and learning software applications intended for young and very young children. However, many of these devices have a prominent push button switch called the “home button,” which is directly accessible for young children. This is a problem because once the home button is pressed, young children leave the game or application and have full adult access to the device. Within seconds, young children can and do destroy important data on these devices by randomly touching the images on the touch screen. Examples of important data that can be deleted or altered include contacts in the address book, events in the calendar, photos, movies, electronic messages, and applications. Subsequent to pressing the home button, young children can also inadvertently send email messages or instant messages, place phone calls, and activate various other applications. Many manufacturers of personal electronic devices currently do not allow any software to disable the home button, nor do they offer any means to disable the home button. Currently, young children cannot play games on personal electronic devices without adults risking data destruction due to the prominence of the home button on all these personal electronic devices.

What is needed is a means for an adult to safely child proof their personal electronic device without sacrificing their own use of the device. Specifically the means should prevent a child from pressing the home button and inadvertently misusing the device while at the same time maintaining the device's function and ease of use for the adult.

### BRIEF SUMMARY

The present invention solves the problem of children accessing adult functions of Apple® iPhone®, iPad™, and iPod Touch®, and other personal electronic devices by physically preventing young children from being able to active the home button. The current invention does this while still allowing adults to activate the home button and maintain access to the adult functions of their personal electronics device.

It is important to note that the present invention is applicable to any recessed push button switch, not just to buttons on Apple® iPhone®, iPad™, and iPod Touch® devices.

The current invention provides an apparatus for preventing the actuation of a recessed push button by a child user while maintaining the accessibility of the recessed push button for an adult user including an oval strip or cap with a top surface and a bottom surface. An adhesive layer is disposed on the bottom surface and the remaining portions of the cap are made of a semi-rigid material. The semi-rigid material is rigid enough to prevent the child user from bending the cap in a downward direction, but is soft or pliable enough for the adult user to bend the cap in the same downward direction.

In one embodiment, a hole is defined through the center of the cap.

In another embodiment, the top surface of the cap is comprised of a first laminate. A center laminate is then disposed beneath the first laminate, and the bottom surface of the cap is comprised of a second laminate disposed beneath the center laminate, forming a multi-layered cap. The first and second laminates are made of a first semi-rigid material with a first rigidity. The center laminate in turn is made of a second semi-rigid material with a second rigidity that is greater than the first rigidity of the first and second laminates. Additionally, the center laminate is located only in a center portion of the cap and is contained between the first and second laminate layers in a “sandwiched” configuration.

In one particular embodiment, a hole is defined through the first laminate, the center laminate, and the second laminate in the center of the cap.

In yet another embodiment, the bottom surface of the cap is sized to fit over the recessed push button of a personal electronics device or computing tablet. The cap is preferably approximately 1.25″ wide, approximately 0.5″ tall, and approximately 0.025″ thick. The hole defined in the cap in some select embodiments is preferably approximately 0.125″ in diameter.

In another embodiment, the adhesive layer on the bottom surface of the cap comprises a bittering agent.

The invention further provides a method for preventing the actuation of a recessed push button by a child user while maintaining the accessibility of the recessed push button for an adult user. The method includes disposing a semi-rigid cap over the recessed push button of a personal electronics device, removing a backing coupled to an adhesive layer disposed on a bottom surface of the cap, and applying the cap to the personal electronics device, directly over the recessed push button. The cap then prevents the actuation of the recessed push button by the child user and allows actuation of the recessed push button by the adult user.

In one embodiment, the method step of preventing the actuation of the recessed push button by the child user includes the child user depressing the semi-rigid cap and failing to deform the cap in the downward direction due to the rigidity of the cap.

In another embodiment, the method step of actuating the recessed push button by the adult user includes the adult user depressing the semi-rigid cap and overcoming the rigidity of the cap and deforming the cap in the downward direction, and then actuating the recessed push button with the deformed cap.

In yet another embodiment, the method step of actuating the recessed push button by the adult user includes inserting a paper clip or other pointed object through a hole defined in the semi-rigid cap and then actuating the recessed push button with the pointed object.

In one particular embodiment, the method further includes peeling the semi-rigid cap away from the personal electronics device. The cap may then also be reapplied to the personal electronics device or transferred to another personal electronics device.

In a separate embodiment, the cap is incorporated into a case for the personal electronics device. The case as is known in the art surrounds and protects the personal electronics device from physical impact and other outside elements while the cap prevents the home button from being actuated by a young user. The cap may be an attachment to the case, or alternatively, the case itself may be comprised of the same semi-rigid material as the cap as described above.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a top view of the present invention.

FIG. 2 is a frontal side view of the present invention seen in FIG. 1

FIG. 3 is a three-dimensional perspective view of the present invention seen in FIG. 1.

FIG. 4 is a top view of a second embodiment of the present invention.

FIG. 5 is a frontal side view of the second embodiment of the present invention seen in FIG. 4.

FIG. 6 is a three-dimensional perspective view of the second embodiment of the present invention seen in FIG. 4.

FIG. 7 is an exploded three-dimensional perspective view of the second embodiment of the present invention seen in FIG. 4.

FIG. 8 is a top view of the present invention properly positioned over the “home button” of a personal electronics device.

FIG. 9 is a side view of the present invention properly positioned over the “home button” of a personal electronics device.

FIG. 10 is a top view of the present invention properly positioned over the “home button” of a personal computing tablet.

FIG. 11 is a side view of the present invention properly positioned over the “home button” of a personal computing tablet.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

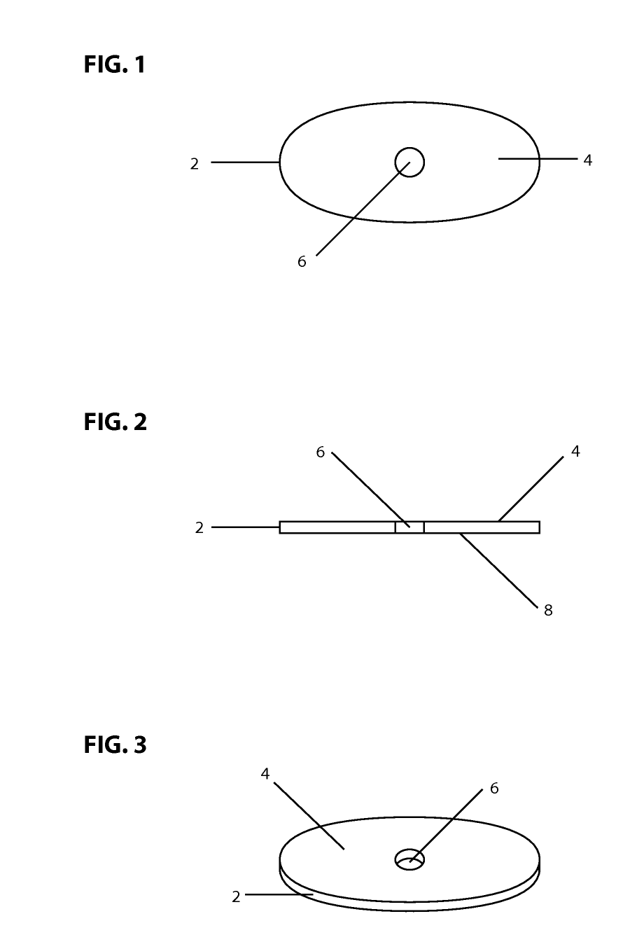

FIG. 1 is a top view of the present invention, a rigid cap for preventing access to the recessed “home button” of a personal electronics device. The edge 2 of the cap is substantially oval in shape when viewed from the top. This shape is preferred over a rectangle, because any corners could injure the finger of a person peeling off the cap from the device it is mounted on. The top surface 4 of the cap is substantially flat. In one embodiment, the cap comprises a small hole 6 defined in the middle of the top surface 4 which allows an adult to activate a push button switch disposed beneath it by using a paperclip or other pointed object. In other embodiments, the top surface 4 does not comprise a hole 6 and is rather a smooth, continuous surface.

FIG. 2 shows the frontal side view of the cap. The top surface 4 is where a finger would attempt to press down, and the bottom surface 8 has an adhesive layer for the purpose of attaching the cap to a personal electronics device as detailed below. The hole 6 is defined from the top surface 4 to the bottom surface 8 of the cap. FIG. 2 shows the thickness of the cap which can be varied to control the rigidity of the cap which in turn affects the necessary force required to activate a push button switch disposed beneath it.

FIG. 3 shows a three-dimensional perspective view of the cap. The top surface 4, side 2, and hole 6 are all visible.

In this embodiment shown in FIGS. 1-3, the cap is approximately 1.25″ wide by 0.5″ tall by 0.025″ thick oval strip of semi-rigid material which has adhesive on the bottom surface 8. The adhesive is reusable and contains a bittering agent to help prevent children from inserting them into their mouths, avoiding possible injuries. The strip includes a removable backing on the adhesive. The hole 6 is approximately 0.125″ in diameter and passes through the approximate 0.025″ thickness of the cap. The cap is attached to an Apple® iPhone®, iPad™, or iPod Touch® by removing the adhesive backing, and then pressing the adhesive side to the device over the home button. The hole 6 in the cap allows precise visual placement of the cap over the home button. The rigidity of the cap prevents young children from being able to press the home button, yet adults still have the strength to press the home button through the semi-rigid cap. Adults can also press the home button using a paperclip or other pointed object. The cap can be removed and used again many times. The necessary strength to activate the home button can be varied by increasing or decreasing the rigidity of the cap. This can be achieved by using more or less rigid materials, or by increasing or decreasing the thickness of the materials comprising the cap. For the purposes of this disclosure, the term “rigidity” refers to the degree of stiffness of a particular object. The greater rigidity an object has, the less flexible it is and the less likely it will bend or deform under pressure.

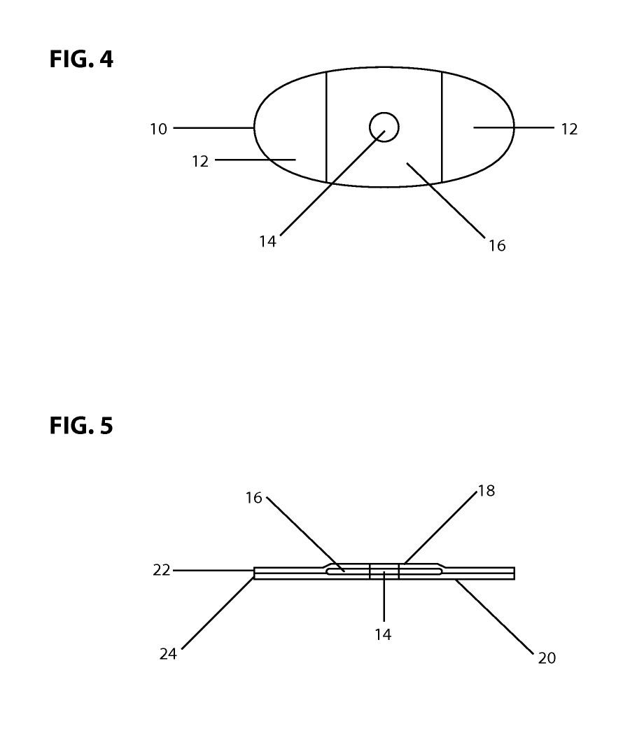

FIG. 4 shows the top view of the second embodiment of the present invention. Here, the cap comprises an edge 10 which is substantially oval in shape when viewed from the top. This shape is preferred over a rectangle, because any corners could injure the finger of a person peeling off the present invention from the device it is mounted on. In this embodiment, the cap comprises a laminated rigid piece of material 16 disposed in the center of the cap. The remaining portions 12 of the cap are comprised of a less rigid material than that of the center laminate 16, increasing its ability to be peeled and thus allowing for easier application and removal of the cap from a personal electronics device. The center laminate 16 and the remaining portions 12 of the cap are preferably comprised of differing plastics or plastic polymers that are well known to those in the art. Specifically, the center laminate 16 is comprised of a material with greater rigidity than the material comprising the remaining portions 12 of the cap. In this embodiment, the cap also comprises a small hole 14 defined in the center of the cap, which allows an adult to activate a push button switch disposed below by using a paperclip or other pointed object.

FIG. 5 shows the front side view of the second embodiment of the present invention. In this embodiment, the cap comprises atop laminate 22 and a bottom laminate 24 which are comprised of a less rigid material than the center laminate 16. The center laminate 16 is slightly wider than the push button switch in which it covers, and the thickness of the center laminate 16 can be varied to control its rigidity, which in turn affects the necessary force required to activate the push button switch of the personal electronics device disposed beneath it. The top surface 18 is where a finger would attempt to press down, and the bottom surface 20 comprises an adhesive layer for the purpose of attaching the cap to a personal electronics device. The hole 14 is defined through the top laminate 22, the center laminate 16, and the bottom laminate 24.

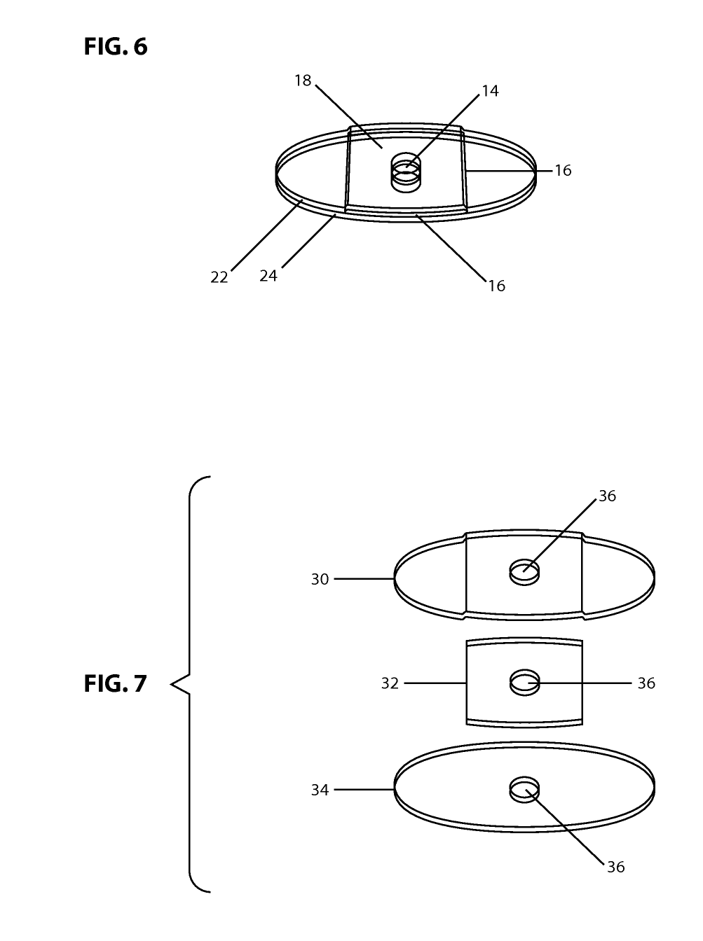

FIG. 6 shows a three-dimensional perspective view of the second embodiment of the cap. The top laminate 22 and bottom laminate 24 are comprised of a less rigid material than the center laminate 16. The top surface 18 is where a finger would attempt to press down. The hole 14 is defined through the top laminate 22, the center laminate 16, and the bottom laminate 24.

FIG. 7 is an exploded three-dimensional perspective view of the second embodiment of the cap. Here, the cap comprises a top laminate 30, a less rigid middle laminate 32, and a bottom laminate 34. The middle laminate 32 is disposed between the top laminate 30 and bottom laminate 34. All laminates 30, 32, 34 have a common hole 36 defined through their respective centers.

In this embodiment seen in FIGS. 4-7, the cap is approximately 1.25″ wide by 0.5″ tall by 0.025″ thick oval strip of semi-rigid material which has adhesive on one side. The adhesive is reusable and contains a bittering agent to help prevent children from inserting them into their mouths, avoiding possible injuries. The cap includes a removable backing on the adhesive. The oval cap is laminated with three parts, a top laminate of less-rigid material 22, a center laminate made of a thicker and more rigid material 16, and a bottom laminate 24, which is similar to the top laminate 22, but with the addition of an adhesive under it. The center laminate 16 is large enough to only cover the push button switch disposed below it, so the left and right ends of the overall cap are less rigid, making it easier to peel off for the adult. The hole 14 is approximately 0.125″ in diameter in the middle of cap, passing all three laminated pieces 22, 16, 24. The cap is attached to a personal electronic device by removing the adhesive backing, and then pressing the adhesive side of the cap to the personal electronic device over the home button. The hole 14 in the cap allows precise visual placement of the cap over the home button. The rigidity of the cap prevents young children from being able to press the home button, yet adults will still have the strength to press the home button through the semi-rigid cap. Adults can also press the home button using a paperclip or other pointed object. The cap can be removed and used again many times. The necessary strength to activate the home button can be varied by increasing or decreasing the rigidity of the cap. This can be achieved by using more or less rigid materials, or by increasing or decreasing the thickness of the materials comprising the cap.

It is to be expressly understood that the specific dimensions of the cap given above are for illustrative purposes only. A cap with dimensions varying from than those specifically listed above is expressly contemplated and is well within the original spirit and scope of the invention. Furthermore, the thickness of the cap may be varied to increase its rigidity for children of varying strengths and ages.

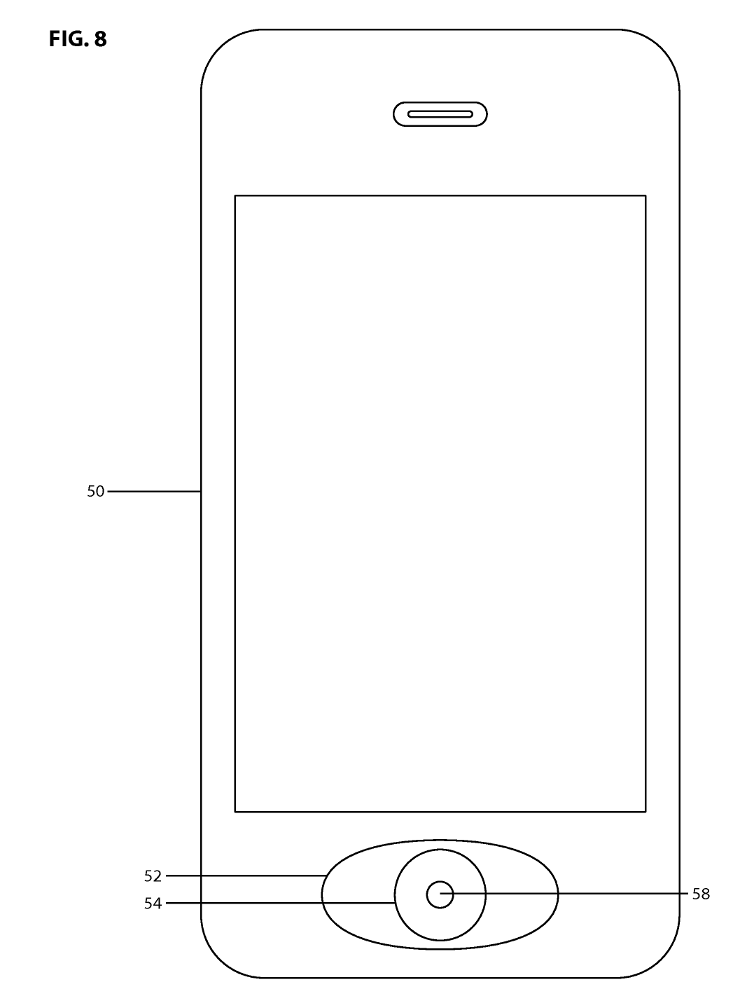

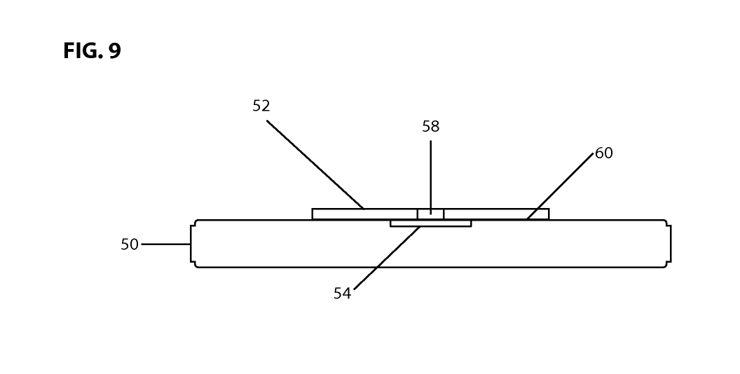

FIG. 8 shows the top view of the cap, designated here with reference numeral 52, properly positioned over the “home button” 54 of a personal electronics device 50 such as an Apple® iPhone® or iPod Touch®. The hole, generally denoted here with reference numeral 58, is defined in the cap 52 and is disposed directly over the center of the “home button” 54, so that an adult can activate the “home button” 54 using a paperclip or other pointed device. In a preferred embodiment, an adult can also activate the “home button” 54 by pressing down on the center of the cap 52 with adequate force. The rigidity of the cap 52 as determined by the material comprising the cap 52 and its relative thickness is such that a small child or toddler cannot push hard enough on the cap 52 and activate the “home button” 54. However the cap 52 is not so rigid so as to prevent an adult with increased dexterity and strength from activating the “home button” 54. It is in this fashion that an adult may download or set up a particular application or software program for a child's use on a personal electronic device 50 without worrying that the child will intentionally or accidentally press the “home button” 54 and exit the desired software, thus exposing the child to the other features of the personal electronic device 50 and causing potential harm.

FIG. 9 shows the side cutaway view of the cap 52 properly positioned over the “home button” 54 of a personal electronics device 50 such as an Apple® iPhone® or iPod Touch®. Adhesive on the bottom 60 of the cap 52 keeps the cap 52 temporarily attached to the personal electronics device 50.

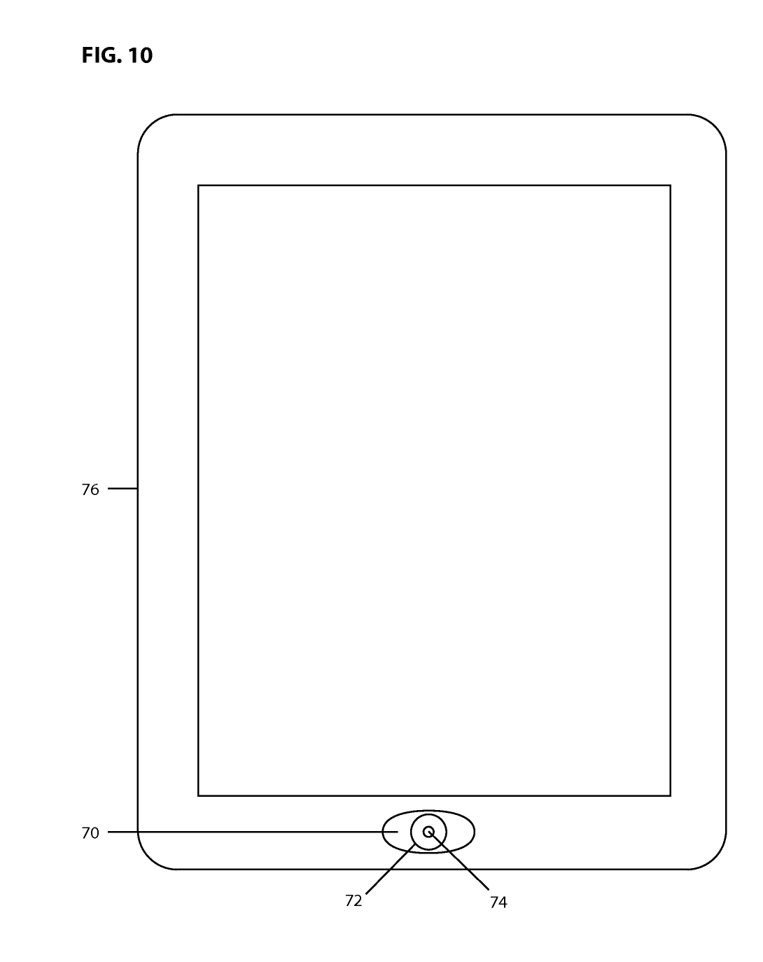

FIG. 10 shows the top view of the cap, shown here in this embodiment labeled as reference numeral 70, properly positioned over the “home button” 72 of a personal computing tablet 76 such as an Apple® iPad™. The hole 74 of the cap 70 is disposed directly over the center of the “home button” 72, so that an adult can activate the “home button” 72 using a paperclip or other pointed device. In a preferred embodiment, an adult can also activate the “home button” 72 by pressing down on the center of the cap 70 with adequate force in the same manner as discussed above with respect to the personal electronics device 50.

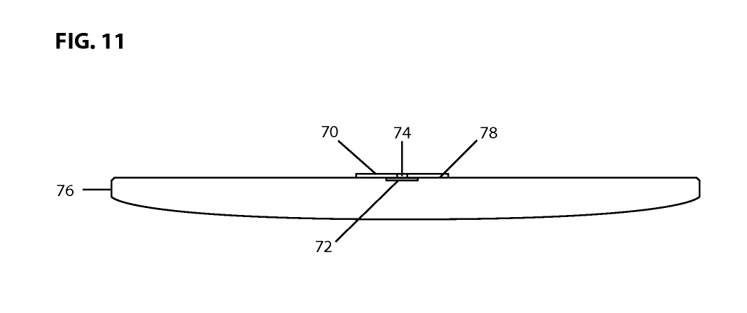

FIG. 11 shows the side cutaway view of the cap 70 properly positioned over the “home button” 72 of a personal computing tablet 76. Adhesive on the bottom 78 of the cap 70 keeps the cap 70 temporarily attached to the personal computing tablet 76.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

I claim:

1. An apparatus for resisting the actuation of a recessed push button by a child user while allowing the actuation of the recessed push button by an adult user comprising:
an cap comprising a top surface and a bottom surface; and
an adhesive layer disposed on the bottom surface,
wherein the cap is comprised of a resilient, semi-rigid material, the semi-rigid material being sufficiently rigid to interfere with the child user bending the cap in a downward direction far enough to actuate the recessed push button, but flexible enough for the adult user to bend the cap in the same downward direction.

2. The apparatus of claim 1 further comprising a hole defined through the center of the cap.

3. The apparatus of claim 1
wherein the top surface of the cap is comprised of a first laminate;
a center laminate disposed beneath the first laminate; and
wherein the bottom surface of the cap is comprised of a second laminate disposed beneath the center laminate.

4. The apparatus of claim 3 where the first and second laminates are comprised of a first semi-rigid material with a first rigidity and where the center laminate is comprised of a second semi-rigid material with a second rigidity,
wherein the second rigidity is greater than the first rigidity.

5. The apparatus of claim 3 where the center laminate is disposed only in a center portion of the cap and is contained between the first and second laminate layers.

6. The apparatus of claim 3 further comprising a hole defined through the first laminate, the center laminate, and the second laminate in the center of the cap.

7. The apparatus of claim 1 where the bottom surface of the cap is sized to fit over the recessed push button of a personal electronics device or computing tablet.

8. The apparatus of claim 1 where the cap is approximately 1.25″ wide.

9. The apparatus of claim 1 where the cap is approximately 0.5″ tall.

10. The apparatus of claim 1 where the cap is approximately 0.025″ thick.

11. The apparatus of claim 2 where the hole is approximately 0.125″ in diameter.

12. The apparatus of claim 1 where the adhesive layer on the bottom surface of the cap comprises a bittering agent.

13. A method for resisting the actuation of a recessed push button by a child user while allowing the actuation of the recessed push button by an adult user comprising:
removing a backing coupled to an adhesive layer disposed on a bottom surface of a resilient, semi-rigid cap;
disposing the resilient, semi-rigid cap over the recessed push button of a personal electronics device;
resisting the actuation of the recessed push button when actuation is attempted by the child user by pressing on the cap; and
allowing actuation of the recessed push button when actuation is attempted by the adult user by pressing on the cap.

14. The method of claim 13 where resisting the actuation of the recessed push button by the child user comprises:
the child user depressing the semi-rigid cap; and
failing to deform the cap in the downward direction sufficiently to actuate the push button due to the rigidity of the cap.

15. The method of claim 14 where allowing actuation of the recessed push button by the adult user comprises:
the adult user depressing the semi-rigid cap; and
overcoming the rigidity of the cap and deforming the cap in the downward direction by a displacement sufficient to actuate the recessed push button with the deformed cap.

16. The method of claim 13 where allowing actuation of the recessed push button by the adult user comprises:
inserting a pointed object through a hole defined in the semi-rigid cap; and
actuating the recessed push button with the pointed object.

17. The method of claim 13 further comprising peeling the semi-rigid cap away from the personal electronics device to allow remove selective allowability of actuation of the push button.

18. The method of claim 17 further comprising reapplying the semi-rigid cap to the personal electronics device to reinstate selectively allowabilty of actuation of the push button.

19. An apparatus for providing selective access to operation of an electronics device according to manual dexterity of the user comprising:
a push button or pressure sensitive master control of the electronics device, activation of the master control being required to operate the electronics device; and
a resilient barrier for covering the master control and preventing direct contact or pressure to be applied thereto unless applied with at least a predetermined minimum force in a predetermined manner
whereby a user having insufficient dexterity to apply the at least predetermined minimum force in the predetermined manner will be substantially prevented from operating the electronics device.

20. The apparatus of claim 19 where the resilient barrier is selectively detachable from and reattachable to the electronics device.
